(19) United States
(12) Patent Application Publication
(10) Pub. No.: US 2009/0297292 A1
(43) Pub. Date: Dec. 3, 2009

(54) SCREW FASTENER

(75) Inventors: Kenichi KATAYAMA, OGAKI-SHI (JP); Yoshinori MORIGUCHI, KAKAMIGAHARA-SHI (JP); Hiroshi FUJII, AICHI-GUN (JP); Naoki SASE, TOYAMA-SHI (JP)

Correspondence Address: LUCAS & MERCANTI, LLP, 475 PARK AVENUE SOUTH, 15TH FLOOR, NEW YORK, NY, 10016, US

(73) Assignee: KABUSHIKI KAISHA IMASEN DENKI SEISAKUSHO, Inuyama-shi (JP)

(21) Appl. No.: 12/125,526

(22) Filed: May 22, 2008

(30) Foreign Application Priority Data
May 25, 2007 (JP) 2007-139252

(51) Int. Cl. F16B 23/00

(52) U.S. Cl. 411/402

(57) ABSTRACT

This invention provides a bolt having threads that performs anti-loosening function and that maintains a specified thread strength, a bolt that also enables manufacturing costs to be reduced. The thread of the step lock bolt is constructed so to include a play side flank formed having a specified lead angle and a pressure side flank formed into a step like configuration, in which a flat portion whose lead angle is 0 (zero) and an inclined portion whose lead angle is steep alternate continuously.

### CROSS-REFERENCE TO RELATED APPLICATION

The present application claims priority under 35 U.S.C. §119 to Japanese Patent Application No. JP2007-139252. The content of the application is incorporated herein by reference.

### BACKGROUND OF THE INVENTION

1. Field of the Invention

The present invention relates to a screw fastener such as a bolt having threads that perform an anti-loosening function.

2. Description of the Related Art

Conventionally, a step lock bolt shown in non-patent documents 1-3 described below has been known as a screw fastener having threads that perform an anti-loosening function. In such a step lock bolt, fine step portions and inclined portions are provided on the flank of a thread of the bolt so as to prevent the bolt from loosening as the result of plastic deformation of these threads, or of a mating member, at times that the bolt is being driven.

Non-patent document 1: Journal of Materials Processing Technology Vol, 56, p 321-332, “Development of Antiloosening Screw Fasteners” H, Fujii et al. 1996.

Non-patent document 2: Journal of Japan Society of Mechanical Engineers, Vol. C 62 (No. 597), p 1963-1968, “Analysis of Screw Fastener Loosening and Development of Evaluation Method”, Hiroshi, Fujii et al. 1996

Non-patent document 3: Journal of Japan Society of Mechanical Engineers, Vol. C 62 (No. 596), p 1527-1532, “Analysis of Loosening Mechanism of Screw Fastener and Development of Loosening Test Method”, Hiroshi Fujii et al, 1996

FIG. 4A is a perspective view showing a conventional step lock bolt 100 and FIG. 4B is an enlarged perspective view of a thread 120 of FIG. 4A.

As shown in FIGS. 4A, 4B, the above-described conventional step lock bolt 100 is formed into a step-like configuration such that fine flat portions 121a, 122a (section having a gentle lead angle) and inclined portions 121b, 122b (section having a steep lead angle) alternate continuously on a pressure side flank 121 and a play side flank 122 of the thread 120 of the screw 110.

Thus, if the step lock bolt 100 is compared with a bolt having normal threads (threads in which the lead angles of both flanks are predetermined) on a basis of their effective leads being assumed to be equal, the sectional area of the thread of the step lock bolt 100, when cut through a plane perpendicular to the spiral line is smaller, and in consequence the strength of the entire thread can be reduced. Particularly, as the length of the flat portions 121a, 122a increases, the sectional area of the thread decreases.

In order to form both flanks 121, 122 into a step-like configuration such as been described above, it is necessary to adjust with a high degree of precision the relative positions between the movable side die and the fixed side die for forming both flanks 121, 122. In consequence, working efficiency is reduced and increases in manufacturing costs result.

In a step lock bolt 100 processed in a state in which the relative positions of the movable side die and the fixed side die are not compatible with each other, the length of the flat portion 121a, which makes sliding contact with a mating side member such as a nut, is reduced, and effectiveness in preventing loosening of the bolt in consequence diminished. Particularly if the quantity of flat portions 121a (hereinafter referred to as step number depending on a case) is increased at times that a turn is made around an axis along a spiral line and the length of the flat portion 121a is further reduced, and effectiveness in preventing loosening of the bolt is reduced even further.

On the other hand, if the quantity of steps is decreased and the length of the flat portion 121a is increased in order to inhibit any reduction in the effectiveness of preventing loosening of the bolt, the sectional area of the thread is reduced in sizes, as has been described above, and a different problem arise, insofar that strength becomes inadequate.

### SUMMARY OF THE INVENTION

The present invention has been achieved to solve the above-described problem and an object of the invention is to provide a screw fastener having threads that perform an anti-loosening function and that maintains a specified degree of thread strength. A screw fastener that is capable of ensuring that manufacturing costs can be reduced.

To achieve the above object, the present invention provides a screw fastener having threads 20 comprising: a play side flank 22 formed so as to have a specified lead angle; and a pressure side flank 22 formed such that sections having a gentle lead angle and sections having a steep angle alternate continuously.

The thread of the screw fastener according to an aspect of the present invention is constructed so as to include a play side flank formed with a specified lead angle and a pressure side flank that is formed into a step-like configuration, in which sections having a gentle lead angle and a section having a steep lead angle alternate continuously.

As a result of such a formation, the effective lead of the pressure side flank is an average of a section having a gentle lead angle and a section having a steep lead angle. Further, because frictional force to a mating side member in the section having the gentle lead angle of the pressure side flank, as a result of a force in the axial direction, is predominant, the counterforce to the loosening of the bolt exerts a strong anti-loosening effect as a result of the frictional force of the section having the gentle lead angle while maintaining a large effective lead. Thus, even if only the pressure side flank is formed into a step-like configuration, an adequate anti-loosening effect can still be exerted.

To enhance effectiveness in preventing loosening of the bolt, it is possible for the length of the section having a gentle lead angle to be increased, by reducing the quantity of steps, in other words the number of sections having a gentle lead angle, at times that a single turn around the axis of the bolt is made along its spiral line, and in consequence for a load applied at the section having the gentle lead angle to be increased, thereby increasing frictional force between the section having the gentle lead angle and the mating side member.

Because, according to the present invention, the pressure side flank is formed so as to have a s step-like configuration, the play side flank is formed so as to have a specified lead angle, the sectional area of the thread, when cut through a plane perpendicular to the spiral line, is larger than a sectional area that is present in a case where both flanks are formed into a step-like configuration, at an end portion at which the pressure side flank and the play side flank are separated from each other and which end portion is a side end portion of the section having a gentle lead angle.

Because the section having the gentle lead angle makes sliding contact with the mating side member in such a way that the thread bites into the mating side member at a side end portion of the section having an increased sectional area and the gentle lead angle, any reduction in the strength of the entire thread can be inhibited even if the quantity of steps is reduced so as to improve effectiveness in preventing loosening of the bolt.

Further, because the length of the section having a gentle lead angle can be increased, and any reduction in the strength of the entire thread can at the same time be inhibited, the repercussions on the length of the section having a gentle lead angle caused by the incompatibility of the relative positions between the movable side die and the fixed side die for forming both flanks can be mitigated. Consequently, adjustment of the relative positions between the movable side die and the fixed side die at times of rolling can be achieved with an allowance. Working efficiency is consequently improved and manufacturing costs can be reduced. Therefore, threads that can perform an anti-loosening function are produced, the strength of threads is maintained and further, manufacturing costs can be reduced.

Further, because the play side flank is formed so as to have a specified lead angle and the pressure side flank is formed in such a way that the section having a gentle lead angle and the section having a steep lead angle alternate continuous, the present invention can easily be distinguished visually from an ordinary screw fastener (a screw fastener in which the lead angles of both flanks are specified) in comparison with cases where both flanks are provided with a section having a gentle lead angle and a section having a steep lead angle.

According to another aspect of the present invention, the pressure side flank can be formed in such a way that the lead angle of the section having a gentle lead angle is zero (flat). Consequently, a frictional force that is proportional to a force in the axial direction acts on a plane at right angles to the axis in a section in which the lead angle of the pressure side flank is zero, and no component force that attempts to rotate the bolt is exerted. Consequently, the frictional force in the section in which the lead angle is zero is intensified, and a more effective method of preventing loosening of the bolt can be achieved.

### BRIEF DESCRIPTION OF THE DRAWINGS

FIG. 1A is a perspective view showing a step lock bolt of the embodiment and FIG. 1B is an enlarged perspective view of the thread of FIG. 1A;

FIG. 2 is an explanatory diagram for comparing the shapes of a thread of the step lock bolt of the embodiment of the present invention, a thread of a conventional step lock bolt and a thread of an ordinary bolt;

FIG. 3 is a sectional view of the threads of respective cut faces taken along the line A-A, line B-B and line C-C parallel to an axis intersecting the spiral line shown in FIG. 2; and

FIG. 4A is a perspective view showing a conventional step lock bolt and FIG. 4B is an enlarged perspective view of the thread of FIG. 4A.

### DESCRIPTION OF THE PREFERRED EMBODIMENTS

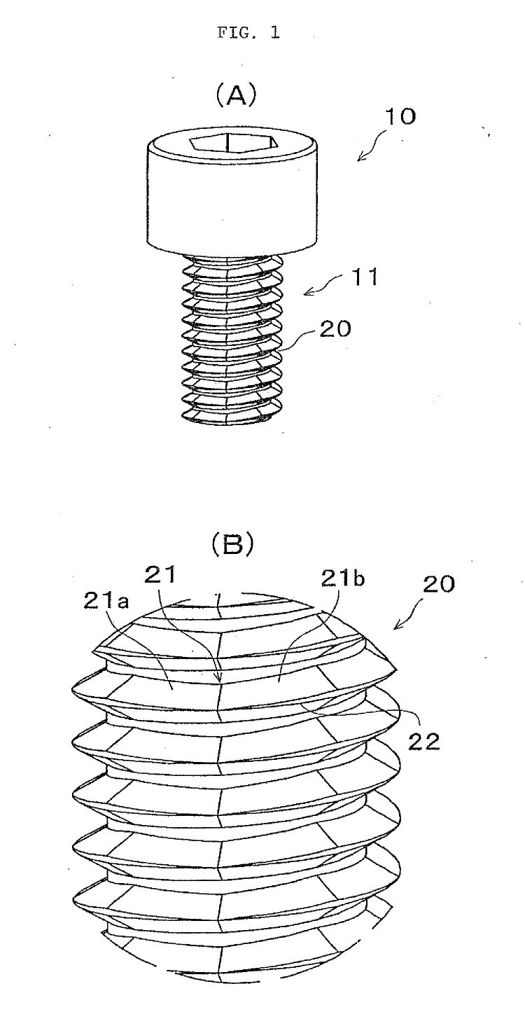

Hereinafter, an embodiment of the present invention will be described in detail with reference to the accompanying drawings. FIG. 1A is a perspective view showing a screw fastener (hereinafter, referred to as a step lock bolt 10 depending on a case) according to this embodiment and FIG. 1B is an enlarged perspective view of threads 20 of FIG. 1A.

As shown in FIG. 1A, the step lock bolt 10 includes a threaded portion 11 having threads 20 formed along a spiral line thereof. A thread 20 has a pressure side flank 21 (upper side of a thread 20 in FIG. 1A) which makes sliding contact with the flank of a mating side member when it is fastened with a mating side member such as a nut and a play side flank 22 (lower side of the thread 20 in FIG. 1A) which remains separate from the mating side member.

The pressure side flank 21 is formed in such a way that a section in which a lead angle is 0 (zero) (hereinafter referred to as a flat portion 21a) and a section in which a lead angle is steep (inclined portion 21b) alternate continuously. On the other hand, the play side flank 22 is formed so as to have a specified lead angle like the flank of an ordinary thread. In this context, the effective lead of the pressure side flank 21 is an average value of the lead angle of the flat portion 21a and the lead angle of the inclined portion 21b, and is equal to the lead angle of the play side flank 22.

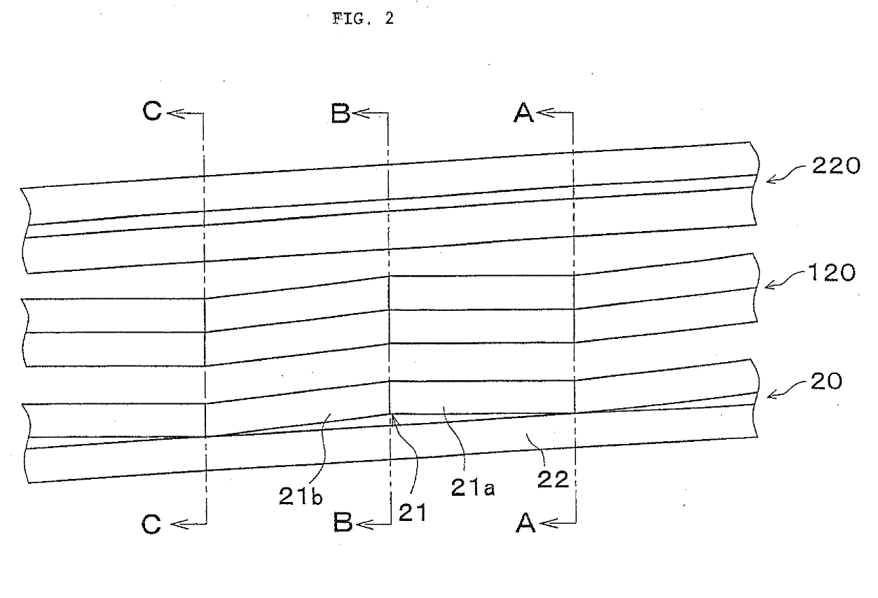

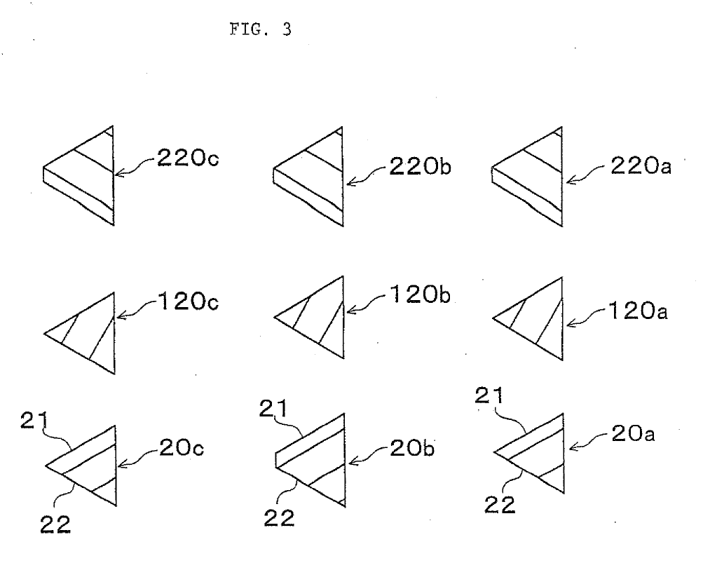

FIG. 2 is an explanatory diagram for comparing the thread 20 of the step lock bolt 10 of this embodiment, the thread 120 of a conventional step lock bolt and the thread 220 of an ordinary bolt. The threads 220 of the ordinary bolt, the thread 120 of the conventional step lock bolt and the thread 20 of the step lock bolt 10 are developed two-dimensionally in order from the top of FIG. 2. FIG. 3 is a sectional view of the respective threads 20, 120 and 220 on each cut face taken along the line A-A, the line B-B and the line C-C parallel to an axis intersecting the spiral line shown in FIG. 2. Cut faces 220a, 220b, 220c of the thread 220 of the ordinary bolt, cut faces 120a, 120b and 120c of the thread 120 of the conventional step lock bolt and cut faces 20a, 20b, 20c of the thread 20 of the step lock bolt 10 are shown in order from the top of FIG. 3.

As shown in FIG. 2 and FIG. 3, the threads 220 of the ordinary bolt have an identical sectional shape on the respective cut faces 220a, 220b, 220c taken along the line A-A, line B-B and line C-C. Further, the threads 120 of the conventional step lock bolt have an identical sectional shape on the respective cut faces 120a, 120b, 120c taken along the line A-A, line B-B and line C-C. Moreover, the respective cut faces 120a, 120b, 120c of the conventional step lock bolt 100 are smaller than the respective but faces 220a, 220b, 220c of the ordinary bolt 200.

As is evident from FIG. 2 and FIG. 3, in the thread 20 of the step lock bolt 10, the cut face 20b taken along the line B-B, which is a cut face of an end portion in which the pressure side flank 21 and the play side flank 22 are apart from each other and which end portion is a side end portion of the flat portion 21a, has the same shape as each cut face 220b of the ordinary bolt 200 and is larger than the cut face 120b of the thread 120 of the conventional step lock bolt.

On the other hand, the cut faces 20a, 20c taken along the lines A-A, C-C, in which the pressure side flank 21 and the play side flank 22 are proximate to each other and which cut faces 20a, 10c are the other side end portions of the flat portion 21a, have the same shape as the respective cut faces 120a, 120c of the thread 120 of a conventional step lock bolt.

The thread 20 of the step lock bolt 10 that has the above-described structure is formed by thread-rolling a bolt raw material before a thread portion is formed while the thread 20 is sandwiched between a movable side die and a fixed side die with a specified pressure applied.

As described above, the section of the thread 20 of the step lock bolt 10 on a cut face taken along the line B-B is larger than the section of the thread 120 of the conventional step lock bolt. Thus, the length of the flat portion 21a can be increased by reducing the quantity of steps, in other word the quantity of flat portions 21a, when a single turn is made around the axis of a conventional step lock bolt along its spiral line, while at the same time any reduction in the strength of the threads is inhibited.

If the length of the flat portion 21a is increased, even if a processing error occurs and in consequence, the length of the flat portion 21a is shorter than a specified length as a result of the incompatibility of the relative positions of the movable side die and the fixed side die at times of rolling, the repercussions of this processing error upon the length of the flat portion 21a are relatively reduced. Thus, adjustment of the relative positions of the movable side die and the fixed side die at the time of rolling can be provided with an allowance.

As described above, the thread 20 of the step lock bolt 10 according to this embodiment is formed so to have the play side flank 22 having a specified lead angle and the pressure-side flank 21 is constructed into a step-like configuration in which the flat portion 21a whose lead angle is 0 (zero) and the inclined portion 21b whose lead angle is steep alternate continuously.

As a result of such a formation, the effective lead of the pressure side flank 21 is an average of the lead angle of the flat portion 21a and the lead angle of the inclined portion 21b. Moreover, because the frictional force to a mating side member in the flat portion 21a of the pressure side flank 21 as a result of a force in the axial direction is predominant, a counterforce against the loosening of the bolt exerts a strong anti-loosening effect as a result of the frictional force of the flat portion 21a while maintaining a large effective lead. Thus, even if only the pressure side flank 21 is formed in a step-like configuration of the kind described above, an adequate anti-loosening effect can still be achieved.

Because the play side flank 22 is formed so to have a specified lead angle while the pressure side flank 21 is formed in a step-like configuration, the sectional area of the thread 20 when it is cut through a plane perpendicular to the spiral line is larger than the sectional area (sectional area of the thread 120 of a conventional step lock bolt) in cases where both the flanks are formed into a step-like configuration at an end portion (an end portion corresponding to the cut face 20b) in which the pressure side flank 21 and the play side flank 22 are separate and which end portion is a side end portion of the flat portion 21a.

The flat portion 21a comes into sliding contact with the mating side member in such a way that the thread 20 bites into the mating side member at a side end portion of the flat portion 21a whose sectional area has increased. As a result, any reduction in the strength of the entire thread 20 is inhibited even if the quantity of steps is reduced so as to enhance effectiveness in preventing loosening of the bolt.

Because the length of the flat portion 21a can be increased and at the same time any reduction in the strength of the entire thread 20 can be inhibited, the repercussions on the length of the flat portion 21a resulting from incompatibility in the relative positions of the movable side die and the fixed side die for forming the both flanks 21, 22 can be reduced. Consequently, the adjustment of the relative positions of the movable side die and the fixed side die at times of rolling can be achieved with a degree of leeway, working efficiency can be improved and in consequence a reduction in manufacturing costs can be achieved. Thus, a thread 20 that performs a function of preventing loosening can be provided so as to maintain the level of thread strength and reduce manufacturing cost.

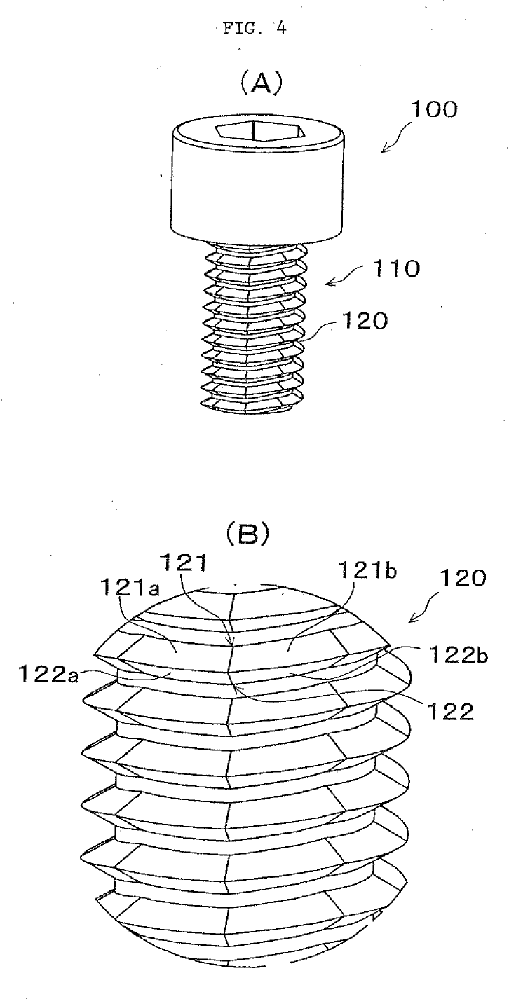

Further, because the play side flank 22 is formed so to have a specified lead angle and the pressure side flank 21 is formed such that the flat portion 21a and the inclined portion 21b alternate continuously, this invention can easily be distinguished visually from an ordinary bolt (a bolt in which the lead angles of both flanks are predetermined) in comparison with the conventional step lock bolt 100 in which both flanks 121, 122 are provided with the flat portions 121a, 122a and inclined portions 121b, 122b (see FIG. 1 and FIG. 4).

Furthermore, the present invention is not restricted to the above-described embodiment but may be carried out as follows and in that case, the same operations and effects as in the above embodiment can be secured.

(1) The flat portion 21a of the pressure side flank 21 is not limited to one in which the lead angle is 0 (zero), but may be formed so as to have a lead angle that is still sufficiently small to conform with the lead angle of the inclined portion 21b.
(2) The pressure side flank 21 and the play side flank 22 of the thread 20 are not restricted to it that as shown in FIG. 2 and FIG. 3, in other words with the outside end portions of the flanks 21, 22 are connected to form a triangular section. Alternatively, the pressure side flank 21 and the play side flank 22 may be constructed so to form a trapezoidal section like the thread 220 of the ordinary bolt.

Although the invention has been disclosed in the context of a certain preferred embodiments, it will be understood that the present invention extends beyond the specifically disclosed embodiments to other alternative embodiments of the invention. Thus, it is intended that the scope of the invention should not be limited by the disclosed embodiments but should be determined by reference to the claims that follow.

What is claimed is:

1. A screw fastener having threads comprising:
a play side flank formed so as to have a specified lead angle; and
a pressure side flank formed in such a way that a section having a gentle lead angle and a section having a steep lead angle are alternate continuously.

2. The screw fastener according to claim 1 wherein the lead angle of the section having a gentle lead angle is zero (flat).
